(19) United States
(12) Patent Application Publication
(10) Pub. No.: US 2026/0166422 A1
(43) Pub. Date: Jun. 18, 2026

(54) METHOD AND DEVICE FOR DISPLAYING THREE-DIMENSIONAL MODEL OF GAME CHARACTER, AND ELECTRONIC DEVICE

(71) Applicant: NETEASE (HANGZHOU) NETWORK CO., LTD., Hangzhou, Zhejiang (CN)

(72) Inventors: Zeyang ZHANG, Hangzhou, Zhejiang (CN); Shuai GUO, Hangzhou, Zhejiang (CN)

(73) Assignee: NETEASE (HANGZHOU) NETWORK CO., LTD., Hangzhou, Zhejiang (CN)

(21) Appl. No.: 19/129,137

(22) PCT Filed: Aug. 2, 2023
(86) PCT No.: PCT/CN2023/110843

§ 371 Date: May 12, 2025

(30) Foreign Application Priority Data
Nov. 15, 2022 (CN) 202211427998.4

(51) Int. Cl. A63F 13/52

(52) U.S. Cl. CPC A63F 13/52

(57) ABSTRACT

A method for displaying a three-dimensional model of a game character includes: determining a target three-dimensional model and a Plurality of preset two-dimensional original texture layers; obtaining size adjustment parameters of the two-dimensional original texture layers in the viewing frustum based on relative positions between the two-dimensional original texture layers and the virtual camera; obtaining target texture layers by adjusting the original sizes of the two-dimensional original texture layers to target sizes based on the size adjustment parameters; and generating the three-dimensional virtual scene background based on the target texture layers, and displaying the target three-dimensional model in three-dimensional virtual scene background.

### CROSS REFERENCE TO RELATED APPLICATIONS

The present application is a National Stage Application of International Application No. PCT/CN2023/110843 filed on Aug. 2, 2023 which is based upon and claims the priority of Chinese Patent Application No. 202211427998.4, entitled “Method and device for displaying three-dimensional model of game character, and electronic device,” filed on Nov. 15, 2022, the entire contents of both of which are incorporated herein by reference in its entirety for all purposes.

### TECHNICAL FIELD

The present disclosure relates to the field of computers, and in particular, to a method and device for displaying a three-dimensional model of a game character, and an electronic device.

### BACKGROUND

Currently, a virtual scene is mainly generated by using a single-layer texture layer. However, since the texture on the single-layer texture layer in this method is relatively single, the display effect of the generated virtual scene is stiff, resulting in the technical problem that the generated virtual scene background lacks three-dimensional effect.

With respect to the above problem, there is proposed no effective solution at present.

### SUMMARY

According to some embodiments of the present disclosure, there is provided a method for displaying a three-dimensional model of a game character. The method may include: determining a target three-dimensional model and a plurality of preset two-dimensional original texture layers, where the plurality of two-dimensional original texture layers are used to generate, through superposition rendering, a three-dimensional virtual scene background for displaying the target three-dimensional model, original sizes of the plurality of two-dimensional original texture layers are the same, and the plurality of two-dimensional original texture layers are located in a coordinate system where a viewing frustum of a virtual camera is located; obtaining size adjustment parameters of the two-dimensional original texture layers in the viewing frustum based on relative positions between the two-dimensional original texture layers and the virtual camera; obtaining target texture layers by adjusting the original sizes of the two-dimensional original texture layers to target sizes based on the size adjustment parameters, where sizes of the target texture layers are matched with sizes of clipping planes in a clipping space, and the clipping space is determined based on the viewing frustum; and generating the three-dimensional virtual scene background based on the target texture layers, and displaying the target three-dimensional model in the three-dimensional virtual scene background.

According to some embodiments of the present disclosure, there is further provided a non-transitory computer-readable storage medium, where a computer program is stored in the non-transitory computer-readable storage medium, and the computer program is configured to, when running, perform the foregoing method for displaying a three-dimensional model of a game character.

According to some embodiments of the present disclosure, there is further provided an electronic device, including a memory and a processor, where the memory stores a computer program, and the processor is configured to run the computer program to perform the foregoing method for displaying a three-dimensional model of a game character.

### BRIEF DESCRIPTION OF THE DRAWINGS

The drawings described here are used to provide a further understanding of the present disclosure and constitute a part of the present disclosure. The illustrative embodiments of the present disclosure and the description of the present disclosure are used to explain the present disclosure and do not constitute an improper limitation on the present disclosure. In the drawings:

FIG. 1 is a block diagram of a hardware structure of a terminal device used for a method for displaying a three-dimensional model of a game character according to some embodiments of the present disclosure;

FIG. 2 is a flowchart of a method for displaying a three-dimensional model of a game character according to some embodiments of the present disclosure;

FIG. 3 is a schematic diagram of a virtual scene generated by using a related technology according to some embodiments of the present disclosure;

FIG. 4 is a schematic diagram of a virtual scene generated by using another related technology according to some embodiments of the present disclosure;

FIG. 5 is a schematic diagram of a plurality of texture layers being unified into a same size according to some embodiments of the present disclosure;

FIG. 6 is a schematic diagram of texture layers with default sizes in an image within a field of view of a camera according to some embodiments of the present disclosure;

FIG. 7 is a schematic diagram of a viewing frustum model of a perspective camera according to some embodiments of the present disclosure;

FIG. 8 is a schematic diagram of a side view of a viewing frustum model of a perspective camera according to some embodiments of the present disclosure;

FIG. 9 is a schematic diagram of positions of texture layers in a viewing frustum model according to some embodiments of the present disclosure;

FIG. 10 is a schematic diagram of texture layers, the size of each texture layer being modified according to a scaling coefficient at a corresponding position, according to some embodiments of the present disclosure;

FIG. 11 is a schematic diagram of an image within a field of view of a camera, after the size of each texture layer is modified according to a scaling coefficient at a corresponding position, according to some embodiments of the present disclosure;

FIG. 12 is a schematic diagram for generating a virtual scene effect according to some embodiments of the present disclosure;

FIG. 13 is a schematic diagram of a device for displaying a three-dimensional model of a game character according to some embodiments of the present disclosure;

FIG. 14 is a schematic diagram of an electronic device according to some embodiments of the present disclosure.

### DETAILED DESCRIPTION

In order to enable those skilled in the art to better understand the solutions of the present disclosure, the technical solutions in the embodiments of the present disclosure will be clearly and completely described below with reference to the accompanying drawings in the embodiments of the present disclosure. Obviously, the described embodiments are only partial embodiments of the present disclosure, not all embodiments of the present disclosure. All other embodiments obtained by those of ordinary skill in the art based on the embodiments of the present disclosure without creative efforts shall fall within the protection scope of the present disclosure.

It should be noted that the terms “first”, “second”, or the like, in the description, claims, and accompanying drawings of the present disclosure are used to distinguish similar objects, and are not necessarily used to describe a specific order or sequence. It should be understood that the data used in this way may be interchanged under appropriate circumstances, so that the embodiments of the present disclosure described here may be implemented in an order other than those illustrated or described here. In addition, the terms “including” and “having” and any deformation of them are intended to cover a non-exclusive inclusion; for example, a process, method, system, product, or device that includes a series of steps or units is not necessarily limited to these steps or units listed clearly, but may include other steps or units that are not clearly listed or inherent to these processes, methods, products, or devices.

According to at least some embodiments of the present disclosure, there is provided a method and device for displaying a three-dimensional model of a game character, and an electronic device, to at least solve the technical problem that the generated virtual scene background lacks three-dimensional effect.

First, the explanations below are used for some nouns or terms appearing in the process of describing the embodiments of the present disclosure.

The viewing frustum is an area visible on a screen in a three-dimensional world, that is, a field of view of a virtual camera, where the virtual camera may be a perspective camera.

The field of view (FOV) refers to the angle of the field of view of the virtual camera, i.e., a range that may be covered by the lens of the perspective camera, and it may be represented by an angle. If an object goes beyond the field of view, it is not collected in the lens of the perspective camera.

The trigonometric function is a function related to angles in mathematics, in which an inner angle of a right triangle may be associated with a ratio between other two sides.

According to some embodiments of the present disclosure, there is provided an embodiment of a method for displaying a three-dimensional model of a game character. It should be noted that the steps shown in the flowchart of the accompanying drawings may be performed in a computer system, for example, with a set of computer-executable instructions. In addition, although a logical order is shown in the flowchart, in some cases, the steps shown or described may be performed in an order different from the order here.

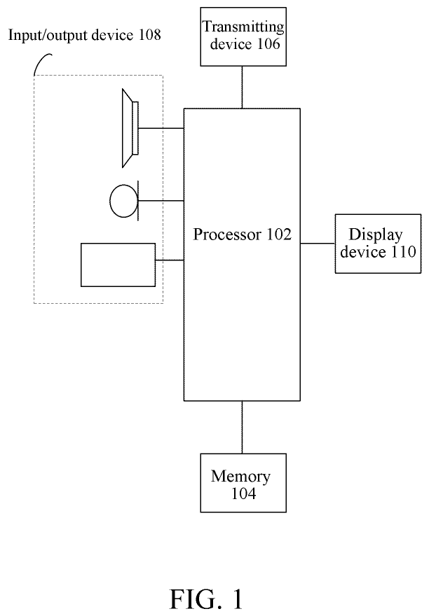

The above method embodiment involved in the present disclosure may be performed by a terminal device, a computer terminal, or a similar computing device. By taking that the method embodiment is performed by a terminal device as an example, the terminal device may be a smart phone, a tablet computer, a palmtop computer, a mobile Internet device, a PAD, a gaming machine, or other terminal devices. FIG. 1 is a block diagram of a hardware structure of a terminal device used for a method for displaying a three-dimensional model of a game character according to some embodiments of the present disclosure. As shown in FIG. 1, the terminal device may include one or more processors 102 (in which only one processor is shown in FIG. 1) and a memory 104 for storing data. The processor 102 may include, but is not limited to, a central processing unit (CPU), a graphics processing unit (GPU), a digital signal processing (DSP) chip, a micro-processing unit (MCU), a field programmable gate array (FPGA), a neural network processing unit (NPU), a tensor processing unit (TPU), an artificial intelligence (AI) type processor, or other devices. In some embodiments of the present disclosure, the terminal device may further include an input/output device 108 and a display device 110.

In some alternative embodiments mainly based on a game scene, the device may further provide a human-machine interaction interface having a touch-sensitive surface. The human-machine interaction interface may sense a finger contact and/or a gesture to perform human-machine interaction with a graphical user interface (GUI). The human-machine interaction function may include the following interactions: creating web pages, drawing, word processing, making electronic documents, playing games, video conferences, instant messaging, receiving and/or transmitting e-mails, call interfaces, playing digital videos, playing digital music and/or web browsing, etc. Executable instructions for performing the above human-machine interaction functions are configured/stored in a readable storage medium or a computer program product executable by one or more processor.

Those skilled in the art may understand that the structure shown in FIG. 1 is merely an example, and does not limit the structure of the terminal device. For example, the terminal device may further include more or less components than those shown in FIG. 1, or the terminal device may have a configuration different from that shown in FIG. 1.

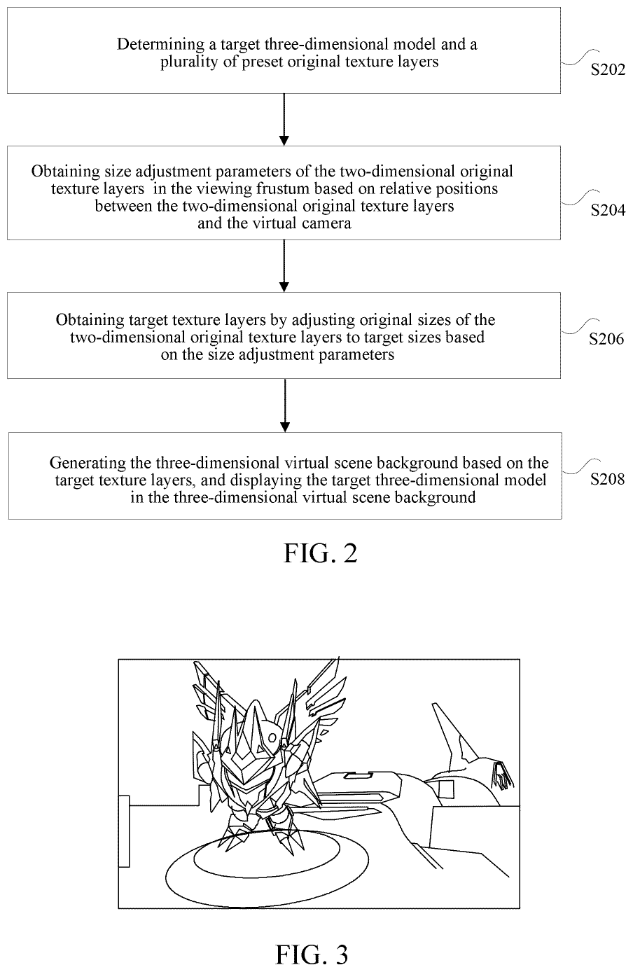

According to some embodiments of the present disclosure, there is provided a method for displaying a three-dimensional model of a game character. FIG. 2 is a flowchart of a method for displaying a three-dimensional model of a game character according to some embodiments of the present disclosure. As shown in FIG. 2, the method includes the following steps.

In step S202, a target three-dimensional model and a plurality of preset two-dimensional original texture layers are determined.

In the technical solution provided in step S202 of the present disclosure, the target three-dimensional model may be the skin of a three-dimensional character of a three-dimensional virtual character in a three-dimensional virtual scene. The plurality of two-dimensional original texture layers may be used to generate, through superposition rendering, a three-dimensional virtual scene background for displaying the target three-dimensional model. The plurality of two-dimensional original texture layers are located in a coordinate system where a viewing frustum of a virtual camera is located, where the three-dimensional virtual scene may be a scene corresponding to the real scene, and may be a game scene in the game field. The viewing frustum may be a viewing frustum model, for example, a scene for displaying the skin of the virtual character in the game application. The three-dimensional virtual scene background may be a three-dimensional background in the three-dimensional virtual scene. The two-dimensional original texture layer may be a layer or a texture layer assembly for generating the three-dimensional virtual scene, and may be a texture layer whose size needs to be adjusted to adapt to the image of the virtual camera. The virtual camera may be a perspective camera. The viewing frustum of the virtual camera may be a pre-established viewing frustum model of the perspective camera. The viewing frustum may be used to represent the field of view of the virtual camera, and the coordinate system where the viewing frustum is located may be a two-dimensional coordinate system or a three-dimensional coordinate system, which is not specifically limited here.

In some embodiments, the plurality of two-dimensional original texture layers are respectively clipped, so that the original sizes of the plurality of two-dimensional original texture layers are unified into a same size, that is, the heights and widths of the plurality of two-dimensional original texture layers may be the same. In some embodiments, the same sizes of the plurality of two-dimensional original texture layers may be determined based on the model of the virtual camera in the three-dimensional virtual scene background. For example, in the case of preferentially causing the two-dimensional original texture layer to be matched with the height of the virtual camera when the two-dimensional original texture layer is adjusted, the virtual camera of the model with the largest width used to display the three-dimensional virtual scene background may be determined, and a width greater than the largest width of the model may be determined as the width in the original size, so that the content of the generated three-dimensional virtual scene background may be displayed in the image of the virtual camera of the model with the largest width, without any lateral leakage in the width direction. That is, the situation that the content of the three-dimensional virtual scene background in the width direction does not fill the image of the virtual camera in the width direction is avoided, where the part that is not filled may be represented as a part filled with black. It should be noted that, in the case of preferentially causing the two-dimensional original texture layer to be matched with the height of the virtual camera when the two-dimensional original texture layer is adjusted, if the content of the three-dimensional virtual scene background in the width direction goes beyond the image of the virtual camera in the width direction, the part of the content of the three-dimensional virtual scene background in the width direction that goes beyond the image of the virtual camera in the width direction may be clipped off.

In step S204, size adjustment parameters of the two-dimensional original texture layers in the viewing frustum are obtained based on relative positions between the two-dimensional original texture layers and the virtual camera.

In the technical solution provided in step S204 of the present disclosure, in the coordinate system where the viewing frustum of the virtual camera is located, the position of the virtual camera is determined as the position of the origin of the coordinate axis, so that the centers of the plurality of two-dimensional original texture layers and the position of the virtual camera are all located on the same coordinate axis, the relative position between each two-dimensional original texture layer and the virtual camera is determined, and the size adjustment parameter of each two-dimensional original texture layer in the viewing frustum is determined based on the relative position. In some embodiments, the relative position may include the original coordinate position of each two-dimensional original texture layer on the coordinate system when the virtual camera is located at the position of the origin of the coordinate system where the viewing frustum is located. The size adjustment parameter may be a size scaling coefficient. For example, in the case of preferentially causing the two-dimensional original texture layer to be matched with the height of the virtual camera when the two-dimensional original texture layer is adjusted, the size scaling coefficient may be a height scaling coefficient for adjusting the height of the two-dimensional original texture layer.

In some embodiments, the size adjustment parameter may be determined based on a setting parameter of the viewing frustum of the virtual camera, for example, may be determined based on a near-clipping plane distance, a far-clipping plane distance, or an image width-height ratio of the viewing frustum. The size adjustment parameter is related to the corresponding two-dimensional original texture layer, that is, the size adjustment parameters corresponding to different two-dimensional original texture layers may be different from each other.

In some embodiments, the size adjustment parameter may be a difference between the size of the target clipping plane of the two-dimensional original texture layer and the original size of the two-dimensional original texture layer or a ratio of the size of the target clipping plane of the two-dimensional original texture layer to the original size of the two-dimensional original texture layer. When the size adjustment parameter is a ratio, the two-dimensional original texture layer is adjusted by multiplying or dividing the original size by the size adjustment parameter. When the size adjustment parameter is a difference, the two-dimensional original texture layer is adjusted by adding the original size to or subtracting the original size by the size adjustment parameter, where the size of the target clipping plane may be an expected size of the two-dimensional original texture layer at the original coordinate position. For example, in the case of preferentially causing the two-dimensional original texture layer to be matched with the height of the virtual camera when the two-dimensional original texture layer is adjusted, the size of the target clipping plane may be an expected height of the two-dimensional original texture layer at the original coordinate position.

It should be noted that, before the size adjustment parameters of the two-dimensional original texture layers in the viewing frustum are obtained based on the relative positions between the two-dimensional original texture layers and the virtual camera, a viewing frustum model may be established first based on the construction parameters of the virtual camera, where the viewing frustum model is the viewing frustum in the embodiment, and the construction parameters of the virtual camera may include the FOV parameter, the near-clipping plane distance parameter, the far-clipping plane distance parameter, the image width-height ratio parameter, etc., which are not specifically limited here.

In step S206, target texture layers are obtained by adjusting the original sizes of the two-dimensional original texture layers to target sizes based on the size adjustment parameters.

In the technical solution provided in step S206 of the present disclosure, the target texture layers may be obtained by respectively adjusting the original sizes of the plurality of two-dimensional original texture layers to the target sizes according to the size adjustment parameters obtained by calculation, and the three-dimensional virtual scene background may be generated based on the plurality of target texture layers, where the target sizes may be the final sizes of the two-dimensional original texture layers, and the sizes of the target texture layers may be the sizes of the corresponding clipping planes in the clipping space.

In some embodiments, the distances between the target texture layers and the virtual camera range from near to far, and the target sizes of the target texture layers also increase from small to large.

In some embodiments, respectively adjusting the original sizes of the plurality of two-dimensional original texture layers to the target sizes according to the size adjustment parameters obtained by calculation may include multiplying, dividing, adding, or subtracting the original size, which is not specifically limited here.

For example, in the case of preferentially causing the two-dimensional original texture layer to be matched with the height of the virtual camera when the original sizes of the plurality of two-dimensional original texture layers is adjusted to the target sizes, the height of the original size is 10 cm, and the size adjustment parameter is 5. When the size adjustment parameter is a ratio, adjusting the original size may be multiplying or dividing the original size by the size adjustment parameter; that is, if 10 is multiplied by 5, the target size is 50 cm; and if 10 is divided by 5, the target size is 2 cm. When the size adjustment parameter is a difference, adjusting the original size may be adding the original size to or subtracting the original size by the size adjustment parameter; that is, if 10 is added to 5, the target size is 15 cm; and if 10 is subtracted by 5, the target size is 5 cm.

In some embodiments, if the size of the two-dimensional original texture layer is just matched with the image of the virtual camera, the size adjustment parameter of the two-dimensional original texture layer may cause the target texture layer to be the same as the two-dimensional original texture layer. For example, if the size adjustment parameter is the ratio of the size of the target clipping plane of the two-dimensional original texture layer to the original size, the value of the size adjustment parameter is 1; and if the size adjustment parameter is the difference between the size of the target clipping plane of the two-dimensional original texture layer and the original size, the value of the size adjustment parameter is 0.

In some embodiments, in the case of preferentially causing the two-dimensional original texture layer to be matched with the height of the virtual camera when the two-dimensional original texture layer is adjusted, the original height of the two-dimensional original texture layer may be adjusted to a target height based on a height scaling parameter to obtain the target texture layer.

It should be noted that each two-dimensional original texture layer in the embodiment may be processed in the foregoing manner to obtain a target texture layer, so as to obtain a plurality of target texture layers for generating the three-dimensional virtual scene background.

In step S208, the three-dimensional virtual scene background is generated based on the target texture layers, and the target three-dimensional model is displayed in the three-dimensional virtual scene background.

In the technical solution provided in step S208 of the present disclosure, after each two-dimensional original texture layer is adjusted according to the corresponding size adjustment parameter to obtain a plurality of target texture layers, a special effect may be added between every two adjacent target texture layers among the plurality of target texture layers to finally generate the three-dimensional virtual scene background. In addition, the target three-dimensional model is displayed in the three-dimensional virtual scene background, so as to achieve the purpose of enhancing the spatial effect of the three-dimensional virtual scene background and enriching the performance effect of the three-dimensional virtual scene background. In some embodiments, the position where the special effect is added between every two adjacent target texture layers may be determined according to the scene building requirements, which is not specifically limited here.

According to step S202 to step S208 of the present disclosure, a target three-dimensional model and a plurality of preset original texture layers are determined; a viewing frustum model is established based on the construction parameters of a virtual camera, and then size adjustment parameters of the two-dimensional original texture layers in the viewing frustum are obtained based on the relative positions between the two-dimensional original texture layers and the virtual camera; the original sizes of the two-dimensional original texture layers are adjusted to target sizes based on the size adjustment parameters to obtain target texture layers; and a virtual scene is generated based on the target texture layer corresponding to each two-dimensional original texture layer. According to the embodiments of the present disclosure, the original size of each two-dimensional original texture layer may be automatically adjusted by using the size adjustment parameter of the preset two-dimensional original texture layer in the viewing frustum to obtain the target texture layer; and finally, the three-dimensional virtual scene background is generated based on the target texture layer corresponding to the two-dimensional original texture layer, and the target three-dimensional model is displayed in the three-dimensional virtual scene background, thus achieving the purpose of generating the three-dimensional virtual scene background for the virtual character through superposition of two-dimensional texture layers so as to solve the technical problem that the virtual scene background lacks three-dimensional effect, and achieving the technical effect of improving the three-dimensional effect of the virtual scene background and the generation efficiency of the virtual scene.

The method according to the embodiment is further described below.

In some embodiments, in step S204, obtaining the size adjustment parameters of the two-dimensional original texture layers in the viewing frustum based on the relative positions between the two-dimensional original texture layers and the virtual camera includes: obtaining the size adjustment parameters based on original coordinate positions of the centers of the two-dimensional original texture layers on the coordinate axis.

In some embodiments, the centers of the plurality of two-dimensional original texture layers and the position of the virtual camera are located on the same coordinate axis. The position of the virtual camera may be the position of the origin of the coordinate axis. The plurality of two-dimensional original texture layers are sequentially arranged on the coordinate axis to obtain the original coordinate positions of the plurality of two-dimensional original texture layers on the coordinate axis; then, the size adjustment parameters corresponding to the two-dimensional original texture layers at the original coordinate positions are obtained according to the original coordinate positions; and, the sizes of the two-dimensional original texture layers are adjusted based on the size adjustment parameters. In some embodiments, the two-dimensional original texture layer is a planar graphics, the center of the two-dimensional original texture layer may be a geometric center of the two-dimensional original texture layer, the origin of the coordinate axis may be a zero point of the coordinate axis, the original coordinate position may be a coordinate position of the two-dimensional original texture layer on the coordinate axis, and the size adjustment parameter may be a size scaling coefficient. For example, in the case of preferentially causing the two-dimensional original texture layer to be matched with the height of the virtual camera when the two-dimensional original texture layer is adjusted, the size scaling coefficient may be a height scaling coefficient, and is used to adjust the height of the two-dimensional original texture layer.

For example, the centers of the plurality of two-dimensional original texture layers and the virtual camera are all located on the Z-axis of the coordinate system, and the position of the virtual camera is the position of the zero point of the Z-axis. The plurality of two-dimensional original texture layers are sequentially arranged on the Z-axis to obtain the original coordinate positions of the plurality of two-dimensional original texture layers on the coordinate axis. That is, the original coordinate position of the texture layer 1 is Z1, the original coordinate position of the texture layer 2 is Z2, and the original coordinate position of the texture layer 3 is Z3. Then, the size adjustment parameter of the texture layer 1 at Z1, the size adjustment parameter of the texture layer 2 at Z2, and the size adjustment parameter of the texture layer 3 at Z3 are obtained respectively.

In some embodiments, obtaining the size adjustment parameters of the two-dimensional original texture layers in the viewing frustum based on the original coordinate positions of the centers of the two-dimensional original texture layers on the coordinate axis, includes: determining sizes of target clipping planes corresponding to the original coordinate positions in the clipping space; and, determining the size adjustment parameters based on the sizes of the target clipping planes and the original sizes.

In some embodiments, first, the size of the target clipping plane corresponding to the two-dimensional original texture layer at the original coordinate position may be determined in the clipping space of the virtual camera. Then, a difference between the size of the target clipping plane of the two-dimensional original texture layer at the original coordinate position and the original size, or a ratio of the size of the target clipping plane of the two-dimensional original texture layer at the original coordinate position to the original size may be determined as the size adjustment parameter, where the original size may be the original size of the two-dimensional original texture layer, and the size of the target clipping plane may be the expected size of the two-dimensional original texture layer at the original coordinate position. For example, in the case of preferentially causing the two-dimensional original texture layer to be matched with the height of the virtual camera when the two-dimensional original texture layer is adjusted, the original size may be the original height of the two-dimensional original texture layer, and the size of the target clipping plane may be the expected height of the two-dimensional original texture layer at the original coordinate position.

In some embodiments, a size adjustment parameter may be obtained through calculation by using the following calculation formula.

$${S}_{z} = \frac{{H}_{z}}{{H}_{o}}$$

In the above formula, Sz may be used to represent a size adjustment parameter, i.e., a size scaling coefficient; Hz may be used to represent a size of a target clipping plane of a two-dimensional original texture layer; and HO may be used to represent an original size of the two-dimensional original texture layer.

For example, in the case of preferentially causing the two-dimensional original texture layer to be matched with the height of the virtual camera when the two-dimensional original texture layer is adjusted, the size adjustment parameter Sz may be a height scaling coefficient for adjusting the height of the two-dimensional original texture layer, the size of the target clipping plane Hz may be the height of the target clipping plane, and the original size HO may be the height of the two-dimensional original texture layer.

In some embodiments, determining the sizes of the target clipping planes corresponding to the original coordinate positions in the clipping space includes: determining a first predetermined clipping plane and a second predetermined clipping plane in the clipping space; and, determining the sizes of the target clipping planes based on a size of the first predetermined clipping plane, a size of the second predetermined clipping plane, a first coordinate position of a center of the first predetermined clipping plane on the coordinate axis, a second coordinate position of a center of the second predetermined clipping plane on the coordinate axis, and the original coordinate positions.

In some embodiments, the first predetermined clipping plane and the second predetermined clipping plane may be first determined in the clipping space. Then, the sizes of the target clipping planes may be calculated according to the similar triangle principle and the linear mapping principle based on the size of the first predetermined clipping plane, the size of the second predetermined clipping plane, the first coordinate position of the center of the first predetermined clipping plane on the coordinate axis, the second coordinate position of the center of the second predetermined clipping plane on the coordinate axis, and the original coordinate positions. In some embodiments, the first predetermined clipping plane may be a near-clipping plane, and the second predetermined clipping plane may be a far-clipping plane. The size of the first predetermined clipping plane may be the size of the near-clipping plane, and the size of the second predetermined clipping plane may be the size of the far-clipping plane. For example, in the case of preferentially causing the two-dimensional original texture layer to be matched with the height of the virtual camera when the two-dimensional original texture layer is adjusted, the size of the first predetermined clipping plane may be the height of the near-clipping plane, the size of the second predetermined clipping plane may be the height of the far-clipping plane, the first coordinate position may be the distance between the first predetermined clipping plane and the virtual camera, the second coordinate position may be the distance between the second predetermined clipping plane and the virtual camera, and the distance between the first predetermined clipping plane and the virtual camera is less than the distance between the second predetermined clipping plane and the virtual camera.

In some embodiments, the size of a target clipping plane may be obtained through calculation by using the following calculation formula.

$${H}_{z} = {H}_{f} + ( {H}_{b} - {H}_{f} ) \times ( \frac{Z - {D}_{f}}{{D}_{b} - {D}_{f}} )$$

In the above formula, Z may be used to represent the original coordinate position of a two-dimensional original texture layer on the Z-axis, Df may be used to represent the distance between the near-clipping plane and the virtual camera, Db may be used to represent the distance between the far-clipping plane and the virtual camera, HZ may be used to represent the size of the target clipping plane, Hf may be used to represent the size of the first predetermined clipping plane, and the Hb may be used to represent the size of the second predetermined clipping plane. For example, in the case of preferentially causing the two-dimensional original texture layer to be matched with the height of the virtual camera when the two-dimensional original texture layer is adjusted, HZ may be the height of the target clipping plane, Hf may be the height of the near-clipping plane, and Hb may be the height of the far-clipping plane.

In some embodiments, the method may further include: determining the size of the first predetermined clipping plane based on a field of view of the virtual camera and the first coordinate position.

In some embodiments, it may be known from the tangent trigonometric function that the ratio of one-half of the size of the near-clipping plane to the distance between the near-clipping plane and the virtual camera is the tangent value of one-half of the field of view. Therefore, the size of the first predetermined clipping plane may be obtained through calculation by using the field of view of the virtual camera and the first coordinate position, where the field of view may be the FOV of the perspective camera, i.e., the range that may be covered by the lens of the perspective camera.

In some embodiments, the size of the first predetermined clipping plane may be obtained through calculation by using the following calculation formula.

$${H}_{f} = 2 \times {D}_{f} \times tan ( \frac{FOV}{2} )$$

In the above formula, Hf may be used to represent the size of the first predetermined clipping plane. For example, in the case of preferentially causing the two-dimensional original texture layer to be matched with the height of the virtual camera when the two-dimensional original texture layer is adjusted, Hf may be the height of the first predetermined clipping plane, Df may be used to represent the first coordinate position, i.e., the distance between the first predetermined clipping plane and the virtual camera, and FOV may be used to represent the field of view of the virtual camera.

In some embodiments, the method may further include: determining the size of the second predetermined clipping plane based on the field of view of the virtual camera and the second coordinate position.

In some embodiments, it may be seen from the tangent trigonometric function that the ratio of one-half of the size of the far-clipping plane to the distance between the far-clipping plane and the virtual camera is also a tangent value of one-half of the field of view. Therefore, the size of the second predetermined clipping plane may be obtained through calculation by using the field of view of the virtual camera and the second coordinate position.

In some embodiments, the size of the second predetermined clipping plane may be obtained through calculation by using the following calculation formula.

$${H}_{b} = 2 \times {D}_{b} \times tan ( \frac{FOV}{2} )$$

In the above formula, Hb may be used to represent the size of the second predetermined clipping plane. For example, in the case of preferentially causing the two-dimensional original texture layer to be matched with the height of the virtual camera when the two-dimensional original texture layer is adjusted, Hb may be the height of the second predetermined clipping plane, Db may be used to represent the second coordinate position, i.e., the distance between the second predetermined clipping plane and the virtual camera, and FOV may be used to represent the field of view of the virtual camera.

In some embodiments, in step S206, adjusting the original sizes of the two-dimensional original texture layers to the target sizes based on the size adjustment parameters, includes: obtaining the target sizes the same as the sizes of the target clipping planes by adjusting the original sizes according to the size adjustment parameters.

In some embodiments, the original sizes of the plurality of two-dimensional original texture layers may be respectively adjusted according to the obtained size adjustment parameters, and may be adjusted to the target sizes the same as the sizes of the target clipping plane, where the target size is positively correlated with the distance between the original coordinate position and the virtual camera. That is, when the distance between the two-dimensional original texture layer and the virtual camera ranges from near to far, the target size corresponding to the two-dimensional original texture layer becomes larger and larger.

In some embodiments, when the original sizes of the plurality of two-dimensional original texture layers are adjusted, corresponding scaling may be performed according to the obtained size adjustment parameters. For example, the original sizes may be multiplied, divided, added, or subtracted, which is not specifically limited here.

For example, in the case of preferentially causing the two-dimensional original texture layer to be matched with the height of the virtual camera when the original sizes of the plurality of two-dimensional original texture layers are adjusted to the target sizes, the height of the original size is 10 cm, and the size adjustment parameter is 5. When the size adjustment parameter is a ratio, adjusting the original size may be multiplying or dividing the original size by the size adjustment parameter; that is, if 10 is multiplied by 5, the target size is 50 cm; and if 10 is divided by 5, the target size is 2 cm. When the size adjustment parameter is a difference, adjusting the original size may be adding the original size to or subtracting the original size by the size adjustment parameter; that is, if 10 is added to 5, the target size is 15 cm; and if 10 is subtracted by 5, the target size is 5 cm.

In some embodiments, if the original size of the two-dimensional original texture layer is just the same as the target size, in the case that the size adjustment parameter is the ratio of the size of the target clipping plane of the two-dimensional original texture layer to the original size, the value of the size adjustment parameter is 1; and in the case that the size adjustment parameter is the difference between the size of the target clipping plane of the two-dimensional original texture layer and the original size, the value of the size adjustment parameter is 0.

In some embodiments, in step S208, generating the three-dimensional virtual scene background based on the target texture layers, includes: in response to the original coordinate positions being unchanged, constructing the three-dimensional virtual scene background by using a target texture layer corresponding to each two-dimensional original texture layer.

In some embodiments, after the original sizes of the plurality of two-dimensional original texture layers are respectively adjusted to the target sizes according to the obtained size adjustment parameters, the target texture layer corresponding to each two-dimensional original texture layer is obtained. The original coordinate positions are kept unchanged, and the three-dimensional virtual scene background may be constructed at the original coordinate positions of the two-dimensional original texture layers by using the generated plurality of target texture layers.

In some embodiments, the plurality of two-dimensional original texture layers correspond to a plurality of target texture layers, and generating the three-dimensional virtual scene background based on the target texture layer corresponding to each two-dimensional original texture layer includes: constructing the three-dimensional virtual scene background by using the target texture layer corresponding to each two-dimensional original texture layer and special effect data between every two adjacent target texture layers among the plurality of target texture layers.

In some embodiments, based on the special effect data between every two adjacent target texture layers, the special effect data is added at a required position between every two adjacent target texture layers among the plurality of target texture layers, and then the three-dimensional virtual scene background is constructed based on the target texture layer corresponding to each two-dimensional original texture layer, so as to achieve the purpose of enhancing the spatial effect of the three-dimensional virtual scene background and enriching the performance effect of the three-dimensional virtual scene background, where the special effect data may be used to generate a special effect in the three-dimensional virtual scene background, and the special effect may be a dynamic effect.

In some embodiments, the position where the special effect is added between every two adjacent target texture layers among the plurality of target texture layers may be determined according to the scene building requirements, which is not specifically limited here.

In some embodiments, the original size includes the original width of the two-dimensional original texture layer and the original height of the two-dimensional original texture layer, the size of the clipping plane in the clipping space includes the target width of the clipping plane in the clipping space and the target height of the clipping plane in the clipping space, and the ratio of the original width to the original height is greater than the ratio of the target width to the target height.

In some embodiments, the original size of the two-dimensional original texture layer may include the original width of the two-dimensional original texture layer and the original height of the two-dimensional original texture layer, and the size of the clipping plane in the clipping space may include the target width of the clipping plane in the clipping space and the target height of the clipping plane in the clipping space, and the ratio of the original width to the original height is greater than the ratio of the target width to the target height, so that the content of the generated three-dimensional virtual scene background may be displayed in the image of the virtual camera of the model with the largest width, without any lateral leakage in the width direction. That is, the situation that the content of the three-dimensional virtual scene background in the width direction does not fill the image of the virtual camera in the width direction is avoided, where the part that is not filled may be represented as a part filled with black. The target width of the clipping plane and the target height of the clipping plane in the clipping space may be the width and height of the screen of the device for displaying the three-dimensional virtual scene background.

It should be noted that, in the embodiments of the present disclosure, adjusting the height of the two-dimensional original texture layer based on the size adjustment parameter is only an example adapting to an actual application scene, which is not specifically limited here.

The technical solutions of the embodiments of the present disclosure are further described below with reference to the preferred embodiments.

In the related art, a virtual scene may be displayed by building a real three-dimensional (3D) scene, for example, a scene for displaying the skin of each character in the game of eggy party. FIG. 3 is a schematic diagram of a virtual scene generated by using a related technology according to some embodiments of the present disclosure. As shown in FIG. 3, when a scene is built by using this method, a layout of a display scene needs to be designed, and a component model required for the corresponding scene is made, in which the model reuse rate is low. Therefore, the labor cost for the scene construction is high. In addition, a large number of high-modulus components and rendering-related consumption in the scene will also affect the game performance.

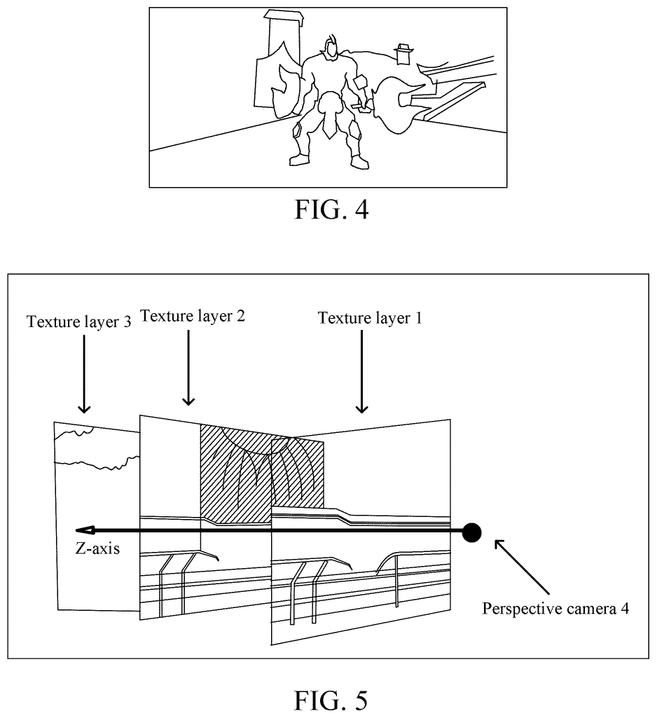

In another related art, a virtual scene may be displayed by using a single background texture layer, for example, the game scene displayed in the game of Honor of Kings. FIG. 4 is a schematic diagram of a virtual scene generated by using another related technology according to some embodiments of the present disclosure. As shown in FIG. 4, the single texture layer may result in that the display scene lacks three-dimensional effect, so that the display effect is relatively stiff. Furthermore, in order to adapt the texture layer to the image size of the camera, the position and size of the texture layer need to be manually adjusted, causing that the matching precision between the image size and the texture layer is low, and there is still a technical problem that the virtual scene background lacks three-dimensional effect.

However, according to the embodiments of the present disclosure, there is provided a method for generating a virtual scene based on multi-layer texture. In the method, a pseudo 3D effect is achieved by combining multi-layer texture with the special effect between texture layers. Furthermore, in order to adapt each texture layer to the image size of the camera, a camera viewing frustum model is constructed by using the parameters related to the scene perspective camera, the accurate position information and the corresponding size of each texture layer are obtained through calculation, and then the position of each texture layer relative to the scene perspective camera is adjusted, thus solving the technical problems that matching precision between the image size and the texture layer is low and the virtual scene background lacks three-dimensional effect.

The foregoing method provided in the embodiments of the present disclosure is further described below, and the method may include the following four parts.

The prepared plurality of texture layers are unified into the same size, and the position of the center of each texture layer is located at the geometric center of texture layer. Each texture layer and the perspective camera in the game are arranged in the same axial direction.

In some embodiments, the width-height ratio of the unified same size needs to satisfy the requirements of the model with the largest width, so as to avoid side leakage of the generated virtual scene in different models.

FIG. 5 is a schematic diagram of a plurality of texture layers being unified into a same size according to some embodiments of the present disclosure. As shown in FIG. 5, the texture layer 1, the texture layer 2, and the texture layer 3 are of the same size. The texture layer 1, the texture layer 2, and the texture layer 3 and the perspective camera 4 are arranged in the same axial direction (for example, the Z axis). That is, the geometric center of each texture layer and the perspective camera are both on the Z axis, and the various texture layers are arranged from near to far according to the positional relationship along the ray direction of the camera.

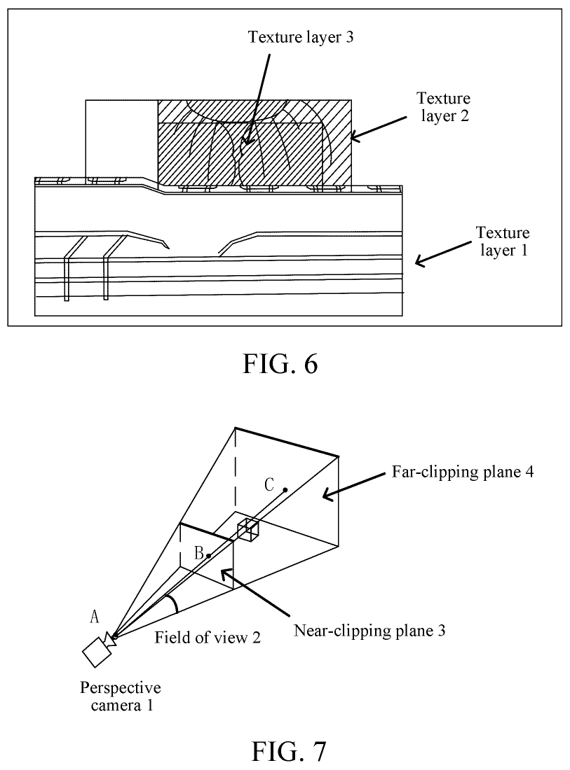

FIG. 6 is a schematic diagram of texture layers with default sizes in an image within a field of view of a camera according to some embodiments of the present disclosure. As shown in FIG. 6, within the field of view of the perspective camera, the texture layer 1, the texture layer 2 and the texture layer 3 with the default sizes do not match the image of the camera, and the relative sizes and positional relationships of the various layers are disordered.

The setting parameters of the perspective camera, including the FOV, a near-clipping plane distance, a far-clipping plane distance, and a width-height ratio of the image, are obtained; and, a viewing frustum model of the perspective camera is constructed based on the setting parameters.

FIG. 7 is a schematic diagram of a viewing frustum model of a perspective camera according to some embodiments of the present disclosure. As shown in FIG. 7, the point A is located at the perspective camera 1, the point B is located on the near-clipping plane 3, the point C is located on the far-clipping plane 4, and the field of view 2 represents the FOV of the perspective camera 1. On the near-clipping plane 3, the black solid line represents the width (Width front, Wf) of the near-clipping plane 3, the black dashed line represents the height (High front, Hf) of the near-clipping plane 3, and the segment line AB from the point A to the point B on the near-clipping plane 3 represents the near-clipping distance (Distance front, Df). On the far-clipping plane 4, the black solid line represents the width (Width back, Wb) of the far-clipping plane 4, the black dashed line represents the height (High back, Hb) of the far-clipping plane 4, and the line segment AC from the point A to the point C on the far-clipping plane 4 represents the far-clipping distance (Distance back, Db).

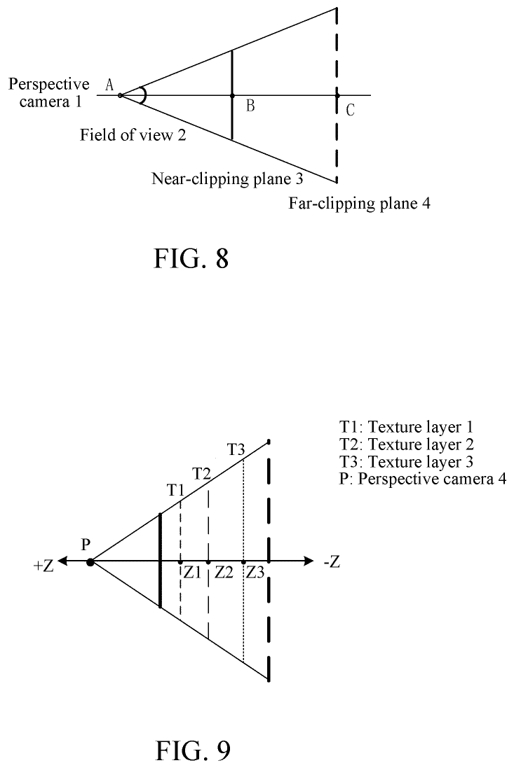

For ease of understanding the calculation principle and the calculation process of the embodiments of the present disclosure, according to the embodiments of the present disclosure, there is further provided a side view of the viewing frustum model. FIG. 8 is a schematic diagram of a side view of a viewing frustum model of a perspective camera according to some embodiments of the present disclosure. As shown in FIG. 8, the point A is located at the perspective camera 1, the field of view 2 represents the FOV of the perspective camera 1, the black solid line represents the near-clipping plane 3, the point B is located on the near-clipping plane 3, the length of the black solid line represents the height Hf of the near-clipping plane 3. The black dashed line represents the far-clipping plane 4, the point C is located on the far-clipping plane 4, and the length of the black dashed line represents the height Hb of the far-clipping plane 4. The line segment AB represents the near-clipping plane distance Df, and the line segment AC represents the far-clipping plane distance Db.

It may be seen from the tangent trigonometric function that the ratio of one-half of the height of the near-clipping plane to the near-clipping plane distance is the tangent value of one-half angle of the field of view, which may be represented by the following formula.

$$tan ( \frac{FOV}{2} ) = ( \frac{{H}_{f}}{2} ) / {D}_{f}$$

The height H_{f} of the near-clipping plane may be obtained by using the foregoing formula, that is:

$${H}_{f} = 2 \times {D}_{f} \times tan ( \frac{FOV}{2} )$$

In the above formula, tan may be used to represent the tangent function, FOV may be used to represent the field of view, Hf may be used to represent the height of the near-clipping plane, and Df may be used to represent the near-clipping plane distance.

Similarly, the ratio of one-half of the height of the far-clipping plane to the far-clipping plane distance is also the tangent value of one-half angle of the field of view, which may be represented by the following formula.

$$tan ( \frac{FOV}{2} ) = ( \frac{{H}_{b}}{2} ) / {D}_{b}$$

The height H_{b} of the far-clipping plane may be obtained through the above formula, that is,

$${H}_{b} = 2 \times {D}_{b} \times tan ( \frac{FOV}{2} )$$

In the above formula, Hb may be used to represent the height of the far-clipping plane, and Db may be used to represent the far-clipping plane distance.

Since the width-height ratio of the perspective camera is the setting parameter of the camera, the width value of the near-clipping plane and the width value of the far-clipping plane may be solved according to the width-height ratio formula of the camera, that is:

$$Ratio = \frac{W}{H}$$

In the above formula, Ratio may be used to represent the width-height ratio of the perspective camera; W may be used to represent the width of the image of the perspective camera, for example, the width of the near-clipping plane or the width of the far-clipping plane; and H may be used to represent the height of the image of the perspective camera, for example, the height of the near-clipping plane or the height of the far-clipping plane.

It should be noted that the method for solving the width value of the near-clipping plane and the width value of the far-clipping plane is the extended content of the embodiments of the present disclosure, and the solved width value of the near-clipping plane and the width value of the far-clipping plane are not applied to the embodiments of the present disclosure.

The position of each texture layer on the Z axis is set according to the positional relationship of each texture layer.

FIG. 9 is a schematic diagram of positions of texture layers in a viewing frustum model according to some embodiments of the present disclosure. As shown in FIG. 9, the black solid line represents the near-clipping plane, the black dashed line represents the far-clipping plane, the position of the perspective camera 4 is at the position of the zero point of the Z-axis, the position of the texture layer 1 (Layer 1) is Z1, the position of the texture layer 2 (Layer 2) is Z2, and the position of the texture layer 3 (Layer 3) is Z3.

In order to accurately adapt each texture layer to the image size of the perspective camera, the size of each texture layer at the corresponding position needs to be adjusted. It may be known according to the similar triangle principle and the linear mapping principle that the calculation formula of the size of the texture layer is as follows.

$${H}_{z} = {H}_{f} + ( {H}_{b} - {H}_{f} ) \times ( \frac{Z - {D}_{f}}{{D}_{b} - {D}_{f}} )$$

In the above formula, Hz may be used to represent the expected height of the texture layer at the corresponding position, Hf may be used to represent the height of the near-clipping plane, Hb may be used to represent the height of the far-clipping plane, Z may be used to represent the corresponding position of the texture layer on the Z-axis, Df may be used to represent the near-clipping plane distance, and Db may be used to represent the far-clipping plane distance. After the expected height of the texture layer at the corresponding position is obtained, the corresponding scaling coefficient may be obtained according to the radio of the expected height of the texture layer at this position to the original height of the texture layer, which may be represented by the following formula.

$${S}_{z} = \frac{{H}_{z}}{{H}_{o}}$$

In the above formula, HO may be used to represent the original height of the texture layer, and SZ may be used to represent the corresponding scaling coefficient.

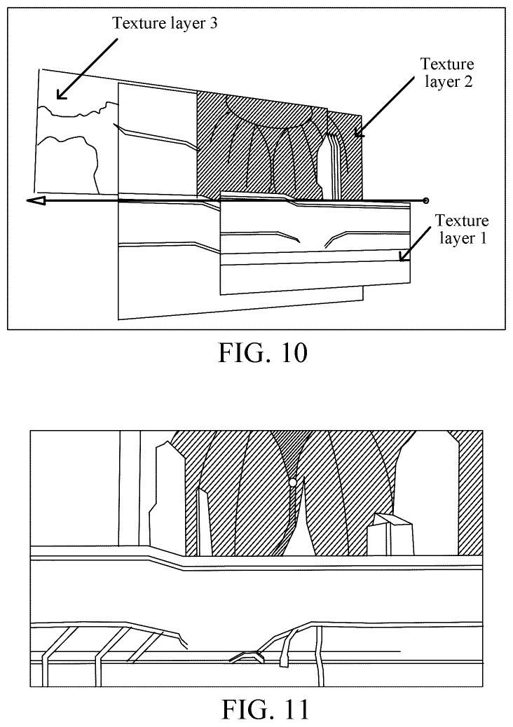

FIG. 10 is a schematic diagram of texture layers, the size of each texture layer being modified according to a scaling coefficient at a corresponding position, according to some embodiments of the present disclosure. As shown in FIG. 10, size adjustment is performed on the texture layer 1, the texture layer 2 and the texture layer 3 according to a scaling coefficient at a corresponding position. FIG. 11 is a schematic diagram of an image within a field of view of a camera, after the size of each texture layer is modified according to a scaling coefficient at a corresponding position, according to some embodiments of the present disclosure. As shown in FIG. 11, each texture layer is accurately matched with the image of the perspective camera. In some embodiments, each texture layer after the size is modified according to the scaling coefficient at the corresponding position is still at the corresponding original position, and the rule that the size becomes larger and larger from near to far is satisfied.

The special effect is added at the required position between the texture layers.

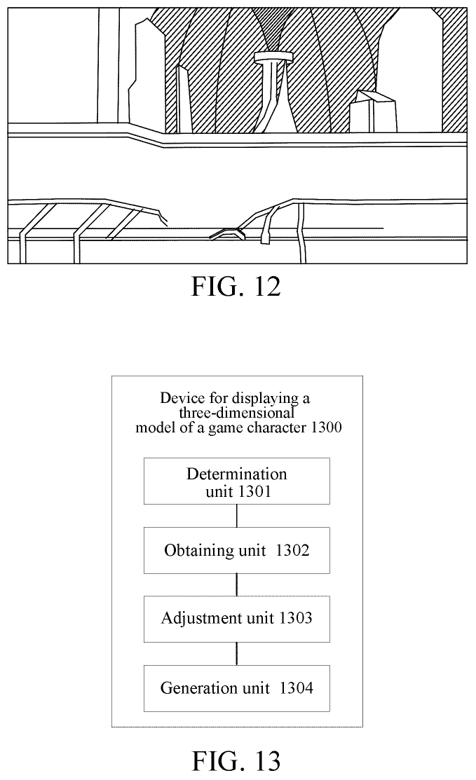

FIG. 12 is a schematic diagram for generating a virtual scene effect according to some embodiments of the present disclosure. As shown in FIG. 12, after the size of each texture layer is adjusted according to the scaling coefficient at the corresponding position, a special effect may be added between the texture layers according to the scene building requirements, so as to achieve the purpose of enhancing the spatial effect of the scene and enriching the performance effect of the scene.

Beneficial effects brought by the technical solutions of the embodiments of the present disclosure may include that: the problems of too high cost and high performance consumption caused by constructing a three-dimensional display scene are avoided, and the implemented effect satisfies the requirements; and, the problems of low efficiency and low precision caused by traditional manual adjustment of parameters of each texture layer are avoided, and the accurate position information and the corresponding size of each texture layer are automatically calculated, so that each texture layer accurately are adaptable to the image size of the camera. In the embodiments of the present disclosure, according to the technical solution that the camera viewing frustum model is constructed based on the related parameters of the scene perspective camera, then the accurate position information and the corresponding size of each texture layer are obtained through calculation, finally, the position of each texture layer relative to the scene perspective camera is adjusted, and the special effect is added between the texture layers, the technical problem that the virtual scene background lacks three-dimensional effect is solved, and the technical effect of improving the three-dimensional effect of the virtual scene background is achieved.

Through the description of the above embodiments, those skilled in the art may clearly understand that the method according to the above embodiments may be implemented by means of software plus a necessary general hardware platform, and certainly may also be implemented by hardware, but in many cases, the former is a better implementation. Based on this understanding, the technical solution of the present disclosure essentially or the part contributing to the related art may be embodied in the form of a software product, and the computer software product is stored in a storage medium (such as a ROM/RAM, a magnetic disk, and an optical disk), and includes several instructions for enabling a terminal device (which may be a mobile phone, a computer, a server, a network device, etc.) to perform the method according to the embodiments of the present disclosure.

In the embodiments, there is further provided a device for displaying a three-dimensional model of a game character, and the device is configured to implement the foregoing embodiments and preferred implementations. As used below, the terms “unit” and “module” may implement a combination of software and/or hardware with predetermined functions. Although the device described in the following embodiments is preferably implemented in software, implementation by hardware or a combination of software and hardware is also possible and conceived.

FIG. 13 is a schematic diagram of a device for displaying a three-dimensional model of a game character according to some embodiments of the present disclosure. As shown in FIG. 13, the device 1300 for displaying a three-dimensional model of a game character includes a determination unit 1301, an obtaining unit 1302, an adjustment unit 1303, and a generation unit 1304.

The determination unit 1301 is configured to determine a target three-dimensional model and a plurality of preset two-dimensional original texture layers, where the plurality of two-dimensional original texture layers are used to generate, through superposition rendering, a three-dimensional virtual scene background for displaying the target three-dimensional model, and original sizes of the plurality of two-dimensional original texture layers are the same, and the plurality of two-dimensional original texture layers are located in a coordinate system where a viewing frustum of the virtual camera is located.

The obtaining unit 1302 is configured to obtain size adjustment parameters of the two-dimensional original texture layers in the viewing frustum based on relative positions between the two-dimensional original texture layers and the virtual camera.

The adjustment unit 1303 is configured to obtain target texture layers by adjusting the original sizes of the two-dimensional original texture layers to target sizes based on the size adjustment parameters, where sizes of the target texture layers are matched with sizes of clipping planes in a clipping space, and the clipping space is determined based on the viewing frustum.

The generation unit 1304 is configured to generate the three-dimensional virtual scene background based on the target texture layers, and display the target three-dimensional model in the three-dimensional virtual scene background.

In some embodiments, the obtaining unit 1302 includes an obtaining module, and the obtaining module is configured to obtain the size adjustment parameters based on original coordinate positions of the centers of the two-dimensional original texture layers on the coordinate axis, where the relative positions include the original coordinate positions.

In some embodiments, the obtaining module includes: a first determination sub-module, configured to determine sizes of target clipping planes corresponding to the original coordinate positions in the clipping space; and a second determination sub-module, configured to determine the size adjustment parameters based on the sizes of the target clipping planes and the original sizes.

In some embodiments, the first determination sub-module is further configured to determine the sizes of the target clipping planes corresponding to the original coordinate positions in the clipping space by using the following steps: determining a first predetermined clipping plane and a second predetermined clipping plane in the clipping space, where a distance between the first predetermined clipping plane and the virtual camera is less than a distance between the second predetermined clipping plane and the virtual camera; and, determining the sizes of the target clipping planes based on a size of the first predetermined clipping plane, a size of the second predetermined clipping plane, a first coordinate position of a center of the first predetermined clipping plane on the coordinate axis, a second coordinate position of a center of the second predetermined clipping plane on the coordinate axis, and the original coordinate positions.

In some embodiments, the first determination sub-module is further configured to determine the size of the first predetermined clipping plane based on a field of view of the virtual camera and the first coordinate position.

In some embodiments, the first determination sub-module is further configured to determine the size of the second predetermined clipping plane based on the field of view of the virtual camera and the second coordinate position.

In some embodiments, the adjustment unit 1303 includes an adjustment module, and the adjustment module is configured to obtain the target sizes the same as the sizes of the target clipping planes by adjusting the original sizes according to the size adjustment parameters, where the target sizes are positively correlated with distances between the original coordinate positions and the virtual camera.

In some embodiments, the generation unit 1304 includes a first construction module, and the first construction module configured to, in response to the original coordinate positions being unchanged, construct the three-dimensional virtual scene background by using the target texture layer corresponding to each two-dimensional original texture layer.

In some embodiments, the generation unit 1304 includes a second construction module, and the second construction module is configured to construct the three-dimensional virtual scene background by using special effect data between every two adjacent target texture layers among the plurality of target texture layers and the target texture layer corresponding to each two-dimensional original texture layer, where the special effect data is used to generate a special effect in the three-dimensional virtual scene background.

In some embodiments, the original size includes an original width of the two-dimensional original texture layer and an original height of the two-dimensional original texture layer, the size of the clipping plane in the clipping space includes a target width of the clipping plane in the clipping space and a target height of the clipping plane in the clipping space, and a ratio of the original width to the original height is greater than a ratio of the target width to the target height.

In the device for displaying a three-dimensional model of a game character according to this embodiment, the determination unit is configured to determine a target three-dimensional model and a plurality of preset two-dimensional original texture layers, where the plurality of two-dimensional original texture layers are used to generate, through superposition rendering, a three-dimensional virtual scene background for displaying the target three-dimensional model, original sizes of the plurality of two-dimensional original texture layers are the same, and the plurality of two-dimensional original texture layers are located in a coordinate system where a viewing frustum of the virtual camera is located; the obtaining unit is configured to obtain size adjustment parameters of the two-dimensional original texture layers in the viewing frustum based on relative positions between the two-dimensional original texture layers and the virtual camera; the adjustment unit is configured to obtain target texture layers by adjusting the original sizes of the two-dimensional original texture layers to target sizes based on the size adjustment parameters, where sizes of the target texture layers are matched with sizes of clipping planes in a clipping space, and the clipping space is determined based on the viewing frustum; and the generation unit is configured to generate the three-dimensional virtual scene background based on the target texture layers, and display the target three-dimensional model in the three-dimensional virtual scene background, thus solving the technical problem that the generated virtual scene background lacks three-dimensional effect, and achieving the technical effect of improving the three-dimensional effect of the virtual scene background and the generation efficiency of the virtual scene.

It should be noted that, the foregoing units and modules may be implemented by using software or hardware. For the latter, the foregoing units and modules may be implemented in the following manners, which are not limited to this. The foregoing units and modules are all located in a same processor; or, the foregoing units and modules are located in different processors in any combination form.

According to some embodiments of the present disclosure, there is further provided a non-transitory computer-readable storage medium, and a computer program is stored in the non-transitory computer-readable storage medium, where the computer program is configured to, when running, perform the steps in any one of the foregoing method embodiments.

In some embodiments, the computer-readable storage medium may include, but is not limited to, any medium that may store a computer program, such as a USB flash drive, a read-only memory (ROM), a random access memory (RAM), a mobile hard disk, a magnetic disk, or an optical disk, etc.

In some embodiments, the computer-readable storage medium may be located in any computer terminal among a computer terminal group in a computer network, or located in any terminal device among a terminal device group.

In some embodiments, the computer-readable storage medium may be configured to store a computer program for performing the following steps:
S1, determining a target three-dimensional model and a plurality of preset two-dimensional original texture layers, where the plurality of two-dimensional original texture layers are used to generate, through superposition rendering, a three-dimensional virtual scene background for displaying the target three-dimensional model, original sizes of the plurality of two-dimensional original texture layers are the same, and the plurality of two-dimensional original texture layers are located in a coordinate system where a viewing frustum of a virtual camera is located;
S2, obtaining size adjustment parameters of the two-dimensional original texture layers in the viewing frustum based on relative positions between the two-dimensional original texture layers and the virtual camera;
S3, obtaining target texture layers by adjusting the original sizes of the two-dimensional original texture layers to target sizes based on the size adjustment parameters, where sizes of the target texture layers are matched with sizes of clipping planes in a clipping space, and the clipping space is determined based on the viewing frustum; and
S4, generating the three-dimensional virtual scene background based on the target texture layers, and displaying the target three-dimensional model in the three-dimensional virtual scene background.

In some embodiments, the computer-readable storage medium is further configured to store program code for performing the following step: obtaining the size adjustment parameters based on original coordinate positions of the centers of the two-dimensional original texture layers on the coordinate axis, where the relative positions include the original coordinate positions.

In some embodiments, the computer-readable storage medium is further configured to store program code for performing the following steps: determining sizes of target clipping planes corresponding to the original coordinate positions in the clipping space; and determining the size adjustment parameters based on the sizes of the target clipping planes and the original sizes.

In some embodiments, the computer-readable storage medium is further configured to store program code for performing the following steps: determining a first predetermined clipping plane and a second predetermined clipping plane in the clipping space, where a distance between the first predetermined clipping plane and the virtual camera is less than a distance between the second predetermined clipping plane and the virtual camera; and determining the sizes of the target clipping planes based on a size of the first predetermined clipping plane, a size of the second predetermined clipping plane, a first coordinate position of a center of the first predetermined clipping plane on the coordinate axis, a second coordinate position of a center of the second predetermined clipping plane on the coordinate axis, and the original coordinate positions.

In some embodiments, the computer-readable storage medium is further configured to store program code for performing the following step: determining the size of the first predetermined clipping plane based on a field of view of the virtual camera and the first coordinate position.

In some embodiments, the computer-readable storage medium is further configured to store program code for performing the following step: determining the size of the second predetermined clipping plane based on a field of view of the virtual camera and the second coordinate position.

In some embodiments, the computer-readable storage medium is further configured to store program code for performing the following step: obtaining the target sizes the same as the sizes of the target clipping planes by adjusting the original sizes according to the size adjustment parameters, where the target sizes are positively correlated with distances between the original coordinate positions and the virtual camera.

In some embodiments, the computer-readable storage medium is further configured to store program codes for performing the following step: in response to the original coordinate positions being unchanged, constructing the three-dimensional virtual scene background by using the target texture layer corresponding to each two-dimensional original texture layer.

In some embodiments, the computer-readable storage medium is further configured to store program codes for executing the following step: constructing the three-dimensional virtual scene background by using the target texture layer corresponding to each two-dimensional original texture layer and special effect data between every two adjacent target texture layers among the plurality of target texture layers, where the special effect data is used to generate a special effect in the three-dimensional virtual scene background.

In some embodiments, the original size includes an original width of the two-dimensional original texture layer and an original height of the two-dimensional original texture layer, the size of the clipping plane in the clipping space includes a target width of the clipping plane in the clipping space and a target height of the clipping plane in the clipping space, and a ratio of the original width to the original height is greater than a ratio of the target width to the target height.

According to the non-transitory computer-readable storage medium of the embodiment, a target three-dimensional model and a plurality of preset original texture layers are determined; a viewing frustum model is established based on the construction parameters of a virtual camera, and then size adjustment parameters of the two-dimensional original texture layers in the viewing frustum are obtained based on the relative positions between the two-dimensional original texture layers and the virtual camera; the original sizes of the two-dimensional original texture layers are adjusted to the target sizes based on the size adjustment parameters to obtain target texture layers; and a virtual scene is generated based on the target texture layer corresponding to each two-dimensional original texture layer. In other words, in the embodiments of the present disclosure, the original size of each two-dimensional original texture layer may be automatically adjusted by using the size adjustment parameter of the preset two-dimensional original texture layer in the viewing frustum to obtain the target texture layer; and finally, the three-dimensional virtual scene background is generated based on the target texture layer corresponding to the two-dimensional original texture layer, and the target three-dimensional model is displayed in the three-dimensional virtual scene background, thus solving the technical problem that the virtual scene background lacks three-dimensional effect, and achieving the technical effect of improving the three-dimensional effect of the virtual scene background and the generation efficiency of the virtual scene.

Through the description of the foregoing implementations, those skilled in the art may easily understand that the example implementations described here may be implemented by software, or may be implemented by software in combination with necessary hardware. Therefore, the technical solutions according to the embodiments of the present disclosure may be embodied in the form of a software product, and the software product may be stored in a computer-readable storage medium (which may be a CD-ROM, a USB flash disk, a mobile hard disk, etc.) or a network, and includes several instructions to cause a computing device (which may be a personal computer, a server, a terminal device, or a network device, etc.) to perform the method according to the embodiments of the present disclosure.

In some embodiments of the present disclosure, the computer-readable storage medium stores a program product capable of implementing the above-mentioned method of the present embodiment. In some possible implementations, various aspects of the embodiments of the present disclosure may also be implemented in a form of a program product, including program code. When the program product runs on a terminal device, the program code is configured to cause the terminal device to perform the steps described in the foregoing “example method” part of the embodiments according to various example embodiments of the present disclosure. According to embodiments of the present disclosure, the program product for implementing the above method may adapt a portable compact disk read-only memory (CD-ROM) and include program code, and may run on a terminal device, for example, a personal computer. However, the program product of the embodiments of the present disclosure is not limited to this. In the embodiments of the present disclosure, the computer-readable storage medium may be any tangible medium containing or storing a program, and the program may be used by or used in combination with an instruction execution system, apparatus or device.

The program product may be any combination of one or more computer-readable medium. The computer-readable storage medium may be, for example, but not limited to, an electronic, magnetic, optical, electromagnetic, infrared, or semiconductor system, apparatus, or device, or any combination of them. More specific examples of a computer-readable storage medium (a non-exhaustive list) include an electrical connection having one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

It should be noted that the program code included in the computer-readable storage medium may be transmitted by using any suitable medium, including but not limited to wireless transmission medium, wired transmission medium, optical cable, RF, or any suitable combination of the foregoing, etc.

According to some embodiments of the present disclosure, there is further provided an electronic device, including a memory and a processor, where the memory stores a computer program, and the processor is configured to run a computer program to perform the steps in any one of the foregoing method embodiments.

In some embodiments, the electronic device may further include a transmitting device and an input/output device, where the transmitting device is connected to the processor, and the input/output device is connected to the processor.

In some embodiments, the processor may be configured to perform, by using a computer program, the following steps:
S1, determining a target three-dimensional model and a plurality of preset two-dimensional original texture layers, where the plurality of two-dimensional original texture layers are used to generate, through superposition rendering, a three-dimensional virtual scene background for displaying the target three-dimensional model, original sizes of the plurality of two-dimensional original texture layers are the same, and the plurality of two-dimensional original texture layers are located in a coordinate system where a viewing frustum of a virtual camera is located;
S2, obtaining size adjustment parameters of the two-dimensional original texture layers in the viewing frustum based on relative positions between the two-dimensional original texture layers and the virtual camera;
S3, obtaining target texture layers by adjusting the original sizes of the two-dimensional original texture layers to target sizes based on the size adjustment parameters, where sizes of the target texture layers are matched with sizes of clipping planes in a clipping space, and the clipping space is determined based on the viewing frustum; and
S4, generating the three-dimensional virtual scene background based on the target texture layers, and displaying the target three-dimensional model in the three-dimensional virtual scene background.

In some embodiments, the processor may be further configured to perform, by using the computer program, the following step: obtaining the size adjustment parameters based on original coordinate positions of the centers of the two-dimensional original texture layers on the coordinate axis, where the relative positions include the original coordinate positions.

In some embodiments, the processor may be further configured to perform, by using the computer program, the following steps: determining sizes of target clipping planes corresponding to the original coordinate positions in the clipping space; and determining the size adjustment parameters based on the sizes of the target clipping planes and the original sizes.

In some embodiments, the processor may be further configured to perform, by using the computer program, the following steps: determining a first predetermined clipping plane and a second predetermined clipping plane in the clipping space, where a distance between the first predetermined clipping plane and the virtual camera is less than a distance between the second predetermined clipping plane and the virtual camera; and determining the sizes of the target clipping planes based on a size of the first predetermined clipping plane, a size of the second predetermined clipping plane, a first coordinate position of a center of the first predetermined clipping plane on the coordinate axis, a second coordinate position of a center of the second predetermined clipping plane on the coordinate axis, and the original coordinate positions.

In some embodiments, the processor may further be configured to perform, by using the computer program, the following step: determining the size of the first predetermined clipping plane based on a field of view of the virtual camera and the first coordinate position.

In some embodiments, the processor may further be configured to perform, by using the computer program, the following step: determining the size of the second predetermined clipping plane based on a field of view of the virtual camera and the second coordinate position.

In some embodiments, the processor may be further configured to perform, by using the computer program, the following step: obtaining the target sizes the same as the sizes of the target clipping planes by adjusting the original sizes according to the size adjustment parameters, where the target sizes are positively correlated with distances between the original coordinate positions and the virtual camera.

In some embodiments, the processor may be further configured to perform, by using the computer program, the following step: in response to the original coordinate positions being unchanged, constructing the three-dimensional virtual scene background by using the target texture layer corresponding to each two-dimensional original texture layer.

In some embodiments, the processor may be further configured to perform, by using the computer program, the following step: constructing the three-dimensional virtual scene background by using the target texture layer corresponding to each two-dimensional original texture layer and special effect data between every two adjacent target texture layers among the plurality of target texture layers, where the special effect data is used to generate a special effect in the three-dimensional virtual scene background.

In some embodiments, the original size includes an original width of the two-dimensional original texture layer and an original height of the two-dimensional original texture layer, the size of the clipping plane in the clipping space includes a target width of the clipping plane in the clipping space and a target height of the clipping plane in the clipping space, and a ratio of the original width to the original height is greater than a ratio of the target width to the target height.

According to the electronic device of the embodiment, a target three-dimensional model and a plurality of preset original texture layers are determined; a viewing frustum model is established based on the construction parameters of a virtual camera, and then size adjustment parameters of the two-dimensional original texture layers in the viewing frustum are obtained based on the relative positions between the two-dimensional original texture layers and the virtual camera; the original sizes of the two-dimensional original texture layers are adjusted to the target sizes based on the size adjustment parameters to obtain target texture layers; and a virtual scene is generated based on the target texture layer corresponding to each two-dimensional original texture layer. In other words, in the embodiments of the present disclosure, the original size of each two-dimensional original texture layer may be automatically adjusted by using the size adjustment parameter of the preset two-dimensional original texture layer in the viewing frustum to obtain the target texture layer; and finally, the three-dimensional virtual scene background is generated based on the target texture layer corresponding to the two-dimensional original texture layer, and the target three-dimensional model is displayed in the three-dimensional virtual scene background, thus solving the technical problem that the virtual scene background lacks three-dimensional effect, and achieving the technical effect of improving the three-dimensional effect of the virtual scene background and the generation efficiency of the virtual scene.

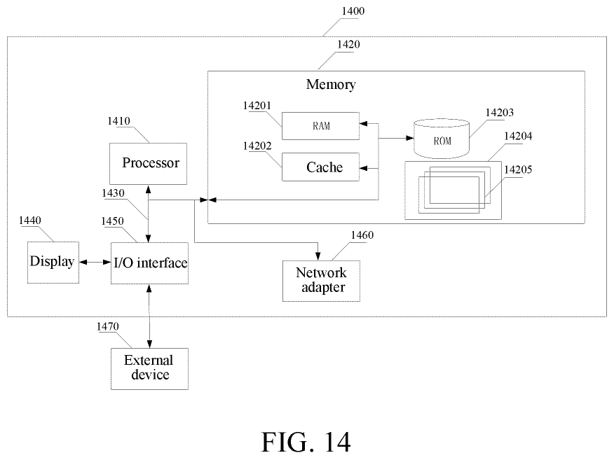

FIG. 14 is a schematic diagram of an electronic device according to some embodiments of the present disclosure. As shown in FIG. 14, the electronic device 1400 is merely an example, and should not bring any limitation to the function and scope of use of the embodiments of the present disclosure.

As shown in FIG. 14, the electronic device 1400 is represented in the form of a general-purpose computing device. The components of the electronic device 1400 may include, but are not limited to, at least one processor 1410, the at least one memory 1420, a bus 1430 connected to different system components (including the memory 1420 and the processor 1410), and a display 1440.

In some embodiments, the memory 1420 stores program code, and the program code may be executed by the processor 1410, causing the processor 1410 to perform the steps described in the method part of the embodiments of the present disclosure according to various example embodiments of the present disclosure.

The memory 1420 may include a readable medium in the form of a volatile storage unit, for example, a random access storage unit (RAM) 14201 and/or a cache storage unit 14202. The memory 1420 may further include a read-only storage unit (ROM) 14203, or may include a non-volatile memory, such as one or more magnetic storage apparatuses, flash memories, or other non-volatile solid-state memories.

In some examples, the memory 1420 may further include a program/utility 14204 having a set of (at least one) program modules 14205. Such program module 14205 includes, but is not limited to, an operating system, one or more applications, other program modules, and program data. Each of these examples or a certain combination of these examples may include an implementation of a network environment. The memory 1420 may further include memories remotely disposed relative to the processor 1410, and the remote memories may be connected to the electronic device 1400 through a network. Examples of the network include, but are not limited to, the Internet, an intranet, a local area network, a mobile communication network, and a combination of them.

The bus 1430 may be one or more of several types of bus structures, including a memory cell bus or a memory cell controller, a peripheral bus, a graphics acceleration port, a processor 1410, or a local bus using any of a plurality of bus structures.

The display 1440 may, for example, a touch screen type liquid crystal display (LCD), which may enable a user to interact with a user interface of the electronic device 1400.

In some embodiments, the electronic device 1400 may also communicate with one or more external devices 1470 (e.g. a keyboard, a pointing device, a Bluetooth device, etc.), may also communicate with one or more devices that enable a user to interact with the electronic device 1400, and/or, may communicate with any device (e.g. a router, a modem, etc.) that enables the electronic device 1400 to communicate with one or more other computing devices. Such communication may be performed via an input/output (I/O) interface 1450. In addition, the electronic device 1400 may communicate with one or more networks, for example, a local area network (LAN), a wide area network (WAN), and/or a public network, such as the Internet, through a network adapter 1460. As shown in FIG. 14, the network adapter 1460 communicates with other modules of electronic device 1400 via bus 1430. It should be understood that although not shown in FIG. 14, other hardware and/or software modules may be used in combination with the electronic device 1400, and the modules may include, but are not limited to, microcode, a device driver, a redundancy processing unit, an external disk drive array, a RAID system, a tape drive, a data backup storage system, or the like.

The electronic device 1400 may further include a keyboard, a cursor control device (such as a mouse), an input/output interface (I/O interface), a network interface, a power supply, and/or a camera.

Those of ordinary skill in the art may understand that the structure shown in FIG. 14 is merely an example, and does not limit the structure of the electronic device. For example, the electronic device 1400 may further include more or fewer components than those shown in FIG. 14, or have a configuration different from that shown in FIG. 1. The memory 1420 may be configured to store a computer program and corresponding data, for example, a computer program and corresponding data corresponding to the method for displaying a three-dimensional model of a game character in the embodiments of the present disclosure. The processor 1410 performs various functional applications and data processing by running the computer program stored in the memory 1420, that is, to implement the foregoing method for displaying a three-dimensional model of a game character.

The sequence numbers of the above embodiments of the present disclosure are merely for description, and do not represent the advantages and disadvantages of the embodiments.

In the above embodiments of the present disclosure, the description of each embodiment has its own emphasis. For the parts that are not described in detail in an embodiment, reference may be made to related descriptions of other embodiments.

In the several embodiments provided in the present disclosure, it should be understood that the disclosed technical content may be implemented in other manners. In some embodiments, the device embodiments described above are merely illustrative. For example, the division of the units may be a logical function division, and there may be another division manner in actual implementation. For example, a plurality of units or components may be combined or may be integrated into another system, or some features may be ignored or not performed. In addition, the displayed or discussed mutual coupling or direct coupling or communication connection may be indirect coupling or communication connection between units or modules through some interfaces, and may be electrical or in other forms.

The units described as separate parts may or may not be physically separate. Components displayed as units may or may not be physical units, may be located in one position, or may be distributed on a plurality of units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such understanding, the technical solutions of the present disclosure essentially, or the part that contributes to related art, or all or a part of the technical solution may be embodied in the form of a software product. The computer software product is stored in a storage medium and includes several instructions for causing a computer device (which may be a personal computer, a server, a network device, etc.) to perform all or part of the steps of the methods described in the embodiments of the present disclosure. The foregoing storage medium includes various media that may store program code, such as a USB flash drive, a read-only memory (ROM), a random access memory (RAM), a mobile hard disk, a magnetic disk, or an optical disk.

The above description is only preferred embodiments of the present disclosure. It should be noted that, for those of ordinary skill in the art, several improvements and modifications may be made without departing from the principle of the present disclosure, and these improvements and modifications should also be considered as the protection scope of the present disclosure.

1. A method for displaying a three-dimensional model of a game character, comprising:
determining a target three-dimensional model and a plurality of preset two-dimensional original texture layers, wherein the plurality of two-dimensional original texture layers are used to generate, through superposition rendering, a three-dimensional virtual scene background for displaying the target three-dimensional model, original sizes of the plurality of two-dimensional original texture layers are the same, and the plurality of two-dimensional original texture layers are located in a coordinate system where a viewing frustum of a virtual camera is located;
obtaining size adjustment parameters of the two-dimensional original texture layers in the viewing frustum based on relative positions between the two-dimensional original texture layers and the virtual camera;
obtaining target texture layers by adjusting the original sizes of the two-dimensional original texture layers to target sizes based on the size adjustment parameters, wherein sizes of the target texture layers are matched with sizes of clipping planes in a clipping space, and the clipping space is determined based on the viewing frustum; and
generating the three-dimensional virtual scene background based on the target texture layers, and displaying the target three-dimensional model in the three-dimensional virtual scene background.

2. The method according to claim 1, wherein centers of the plurality of two-dimensional original texture layers are located on a same coordinate axis of the coordinate system, and the virtual camera is located at an origin of the coordinate axis, wherein obtaining the size adjustment parameters of the two-dimensional original texture layers in the viewing frustum based on the relative positions between the two-dimensional original texture layers and the virtual camera comprises:
obtaining the size adjustment parameters based on original coordinate positions of the centers of the two-dimensional original texture layers on the coordinate axis, wherein the relative positions comprises the original coordinate positions.

3. The method according to claim 2, wherein obtaining the size adjustment parameters based on the original coordinate positions of the centers of the two-dimensional original texture layers on the coordinate axis comprises:
determining sizes of target clipping planes corresponding to the original coordinate positions in the clipping space; and
determining the size adjustment parameters based on the sizes of the target clipping planes and the original sizes.

4. The method according to claim 3, wherein determining the sizes of the target clipping planes corresponding to the original coordinate positions in the clipping space comprises:
determining a first predetermined clipping plane and a second predetermined clipping plane in the clipping space, wherein a distance between the first predetermined clipping plane and the virtual camera is less than a distance between the second predetermined clipping plane and the virtual camera; and
determining the sizes of the target clipping planes based on a size of the first predetermined clipping plane, a size of the second predetermined clipping plane, a first coordinate position of a center of the first predetermined clipping plane on the coordinate axis, a second coordinate position of a center of the second predetermined clipping plane on the coordinate axis, and the original coordinate positions.

5. The method according to claim 4, further comprising:
determining the size of the first predetermined clipping plane based on a field of view of the virtual camera and the first coordinate position.

6. The method according to claim 4, further comprising:
determining the size of the second predetermined clipping plane based on a field of view of the virtual camera and the second coordinate position.

7. The method according to claim 3, wherein adjusting the original sizes of the two-dimensional original texture layers to the target sizes based on the size adjustment parameters comprises:
obtaining the target sizes the same as the sizes of the target clipping planes by adjusting the original sizes according to the size adjustment parameters, wherein the target sizes are positively correlated with distances between the original coordinate positions and the virtual camera.

8. The method according to claim 2, wherein generating the three-dimensional virtual scene background based on the target texture layers comprises:
in response to the original coordinate positions being unchanged, constructing the three-dimensional virtual scene background by using the target texture layers respectively corresponding to the plurality of two-dimensional original texture layers.

9. The method according to claim 1, wherein the plurality of two-dimensional original texture layers correspond to a plurality of target texture layers, and generating the three-dimensional virtual scene background based on the target texture layers comprises:
constructing the three-dimensional virtual scene background by using a target texture layer corresponding to each two-dimensional original texture layer and special effect data between every two adjacent target texture layers among the plurality of target texture layers, wherein the special effect data is used to generate a special effect in the three-dimensional virtual scene background.

10. The method according to claim 1, wherein an original size comprises an original width of a two-dimensional original texture layer and an original height of the two-dimensional original texture layer, a size of a clipping plane in the clipping space comprises a target width of the clipping plane in the clipping space and a target height of the clipping plane in the clipping space, and a ratio of the original width to the original height is greater than a ratio of the target width to the target height.

11. (canceled)

12. A non-transitory computer-readable storage medium, wherein a computer program is stored in the non-transitory computer-readable storage medium, and the computer program is configured to perform a method for displaying a three-dimensional model of a game character when the computer program is run by a processor, wherein the method comprises:
determining a target three-dimensional model and a plurality of preset two-dimensional original texture layers, wherein the plurality of two-dimensional original texture layers are used to generate, through superposition rendering, a three-dimensional virtual scene background for displaying the target three-dimensional model, original sizes of the plurality of two-dimensional original texture layers are the same, and the plurality of two-dimensional original texture layers are located in a coordinate system where a viewing frustum of a virtual camera is located;
obtaining size adjustment parameters of the two-dimensional original texture layers in the viewing frustum based on relative positions between the two-dimensional original texture layers and the virtual camera;
obtaining target texture layers by adjusting the original sizes of the two-dimensional original texture layers to target sizes based on the size adjustment parameters, wherein sizes of the target texture layers are matched with sizes of clipping planes in a clipping space, and the clipping space is determined based on the viewing frustum; and
generating the three-dimensional virtual scene background based on the target texture layers, and displaying the target three-dimensional model in the three-dimensional virtual scene background.

13. An electronic device, comprising a memory and a processor, wherein the memory stores a computer program, and the processor is configured to run the computer program to perform a method for displaying a three-dimensional model of a game character, wherein the method comprises:
determining a target three-dimensional model and a plurality of preset two-dimensional original texture layers, wherein the plurality of two-dimensional original texture layers are used to generate, through superposition rendering, a three-dimensional virtual scene background for displaying the target three-dimensional model, original sizes of the plurality of two-dimensional original texture layers are the same, and the plurality of two-dimensional original texture layers are located in a coordinate system where a viewing frustum of a virtual camera is located;
obtaining size adjustment parameters of the two-dimensional original texture layers in the viewing frustum based on relative positions between the two-dimensional original texture layers and the virtual camera;
obtaining target texture layers by adjusting the original sizes of the two-dimensional original texture layers to target sizes based on the size adjustment parameters, wherein sizes of the target texture layers are matched with sizes of clipping planes in a clipping space, and the clipping space is determined based on the viewing frustum; and
generating the three-dimensional virtual scene background based on the target texture layers, and displaying the target three-dimensional model in the three-dimensional virtual scene background.

14. The non-transitory computer-readable storage medium according to claim 12, wherein the plurality of two-dimensional original texture layers correspond to a plurality of target texture layers, and generating the three-dimensional virtual scene background based on the target texture layers comprises:
constructing the three-dimensional virtual scene background by using a target texture layer corresponding to each two-dimensional original texture layer and special effect data between every two adjacent target texture layers among the plurality of target texture layers, wherein the special effect data is used to generate a special effect in the three-dimensional virtual scene background.

15. The non-transitory computer-readable storage medium according to claim 12, wherein an original size comprises an original width of a two-dimensional original texture layer and an original height of the two-dimensional original texture layer, a size of a clipping plane in the clipping space comprises a target width of the clipping plane in the clipping space and a target height of the clipping plane in the clipping space, and a ratio of the original width to the original height is greater than a ratio of the target width to the target height.

16. The electronic device according to claim 13, wherein centers of the plurality of two-dimensional original texture layers are located on a same coordinate axis of the coordinate system, and the virtual camera is located at an origin of the coordinate axis, wherein obtaining the size adjustment parameters of the two-dimensional original texture layers in the viewing frustum based on the relative positions between the two-dimensional original texture layers and the virtual camera comprises:
obtaining the size adjustment parameters based on original coordinate positions of the centers of the two-dimensional original texture layers on the coordinate axis, wherein the relative positions comprises the original coordinate positions.

17. The electronic device according to claim 16, wherein obtaining the size adjustment parameters based on the original coordinate positions of the centers of the two-dimensional original texture layers on the coordinate axis comprises:
determining sizes of target clipping planes corresponding to the original coordinate positions in the clipping space; and
determining the size adjustment parameters based on the sizes of the target clipping planes and the original sizes.

18. The electronic device according to claim 17, wherein determining the sizes of the target clipping planes corresponding to the original coordinate positions in the clipping space comprises:
determining a first predetermined clipping plane and a second predetermined clipping plane in the clipping space, wherein a distance between the first predetermined clipping plane and the virtual camera is less than a distance between the second predetermined clipping plane and the virtual camera; and
determining the sizes of the target clipping planes based on a size of the first predetermined clipping plane, a size of the second predetermined clipping plane, a first coordinate position of a center of the first predetermined clipping plane on the coordinate axis, a second coordinate position of a center of the second predetermined clipping plane on the coordinate axis, and the original coordinate positions.

19. The electronic device according to claim 18, further comprising one of:
determining the size of the first predetermined clipping plane based on a field of view of the virtual camera and the first coordinate position; or
determining the size of the second predetermined clipping plane based on a field of view of the virtual camera and the second coordinate position.

20. The electronic device according to claim 17, wherein adjusting the original sizes of the two-dimensional original texture layers to the target sizes based on the size adjustment parameters comprises:
obtaining the target sizes the same as the sizes of the target clipping planes by adjusting the original sizes according to the size adjustment parameters, wherein the target sizes are positively correlated with distances between the original coordinate positions and the virtual camera.

21. The electronic device according to claim 16, wherein generating the three-dimensional virtual scene background based on the target texture layers comprises:
in response to the original coordinate positions being unchanged, constructing the three-dimensional virtual scene background by using the target texture layers respectively corresponding to the plurality of two-dimensional original texture layers.
